(19) United States
(12) Patent Application Publication
(10) Pub. No.: US 2009/0322181 A1
(43) Pub. Date: Dec. 31, 2009

(54) ULTRASONIC TRANSDUCER AND METHOD OF MANUFACTURING THE SAME

(75) Inventors: SHUNTARO MACHIDA, Kokubunji (JP); Takashi Kobayashi, Higashimurayama (JP); Taiichi Takezaki, Tachikawa (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/484,685

(22) Filed: Jun. 15, 2009

(30) Foreign Application Priority Data
Jun. 19, 2008 (JP) 2008-159955

(51) Int. Cl. H02N 11/00; G10K 9/12

(52) U.S. Cl. 310/300; 367/140

(57) ABSTRACT

A technique for a capacitive micromachined ultrasonic transducer (CMUT) for achieving high transmitted sound pressure and high receiver sensitivity is provided. An opening portion (7a) having a diameter of, for example, about 10 μm is provided at a center portion of a top electrode (7). The opening portion (7a) is provided to include a contact region (14) therewithin where a lower surface of a second insulating film covering a lower surface of the top electrode (7) and an upper surface of a first insulating film covering an upper surface of a bottom electrode (3) are contacted with each other upon driving the ultrasonic transducer when viewed in plan view, so that the ultrasonic transducer has a structure in which the first and second insulating films are not sandwiched by the top electrode (7) and the bottom electrode (3) in the contact region (14).

### CROSS-REFERENCE TO RELATED APPLICATION

The present application claims priority from Japanese Patent Application No. JP 2008-159955 filed on Jun. 19, 2008, the content of which is hereby incorporated by reference into this application.

### TECHNICAL FIELD OF THE INVENTION

The present invention relates to an ultrasonic transducer and a technique for manufacturing the ultrasonic transducer, and more particularly, the present invention relates to a technique effectively applied to an ultrasonic transducer manufactured by using MEMS (Micro Electro Mechanical System) technology and manufacture of the ultrasonic transducer.

### BACKGROUND OF THE INVENTION

Ultrasonic transducers have been used for diagnosis of tumors etc. within human body or nondestructive inspection of structure, for example. Until now, ultrasonic transducers using vibration of a piezoelectric body have been mainly used. Meanwhile, along with recent progress of MEMS technology, a capacitive micromachined ultrasonic transducer (CMUT) in which a vibrating portion is formed on a silicon substrate is being currently developed toward practical use.

For example, U.S. Pat. No. 6,320,239 B1 (Patent Document 1) discloses a single CMUT, and CMUTs arranged in an array.

In addition, U.S. Pat. No. 6,571,445 B2 (Patent Document 2) discloses a technique of forming a CMUT in an upper layer of a signal processing circuit formed on a silicon substrate.

Moreover, 2007 IEEE Ultrasonics Symposium, p. 511-514 (Non-patent Document 1) describes a CMUT having a structure in which a post (pillar) is formed at a lower portion of a vibrating membrane.

### SUMMARY OF THE INVENTION

A CMUT has advantages of wide frequency bandwidth of available ultrasonic wave or high sensitivity as compared with transducers using piezoelectric body. In addition, a CMUT is manufactured with using LSI (Large Scale Integration) process technology, so that it can be processed with microfabrication techniques. Particularly, it is considered that a CMUT will be indispensable for a transducer in which ultrasonic elements are arranged in an array and each ultrasonic element is independently controlled. That is because, while the above-mentioned transducer is considered to have a huge amount of wirings in the array as wirings to each ultrasonic element are necessary, these wirings can be made easily as the CMUT is manufactured by using LSI process technology. Moreover, that is also because CMUT allows a circuit for processing signals from an ultrasonic wave transceiver unit to be embedded on one semiconductor chip.

Basic structure and operations of an ultrasonic element composing a CMUT will be described with reference to FIGS. 26A and 26B. FIG. 26A illustrates a cross-sectional view of a principal part of an ultrasonic element in a state where no DC voltage and no AC voltage for driving a CMUT are applied and a membrane is not vibrated. FIG. 26B illustrates a cross-sectional view of a principal part of the ultrasonic element in a state where DC voltage and AC voltage for driving the CMUT are applied and the membrane is vibrated.

The structure includes a cavity portion 102 formed in an upper layer of a bottom electrode 101, and an insulating film 103 surrounding the cavity portion 102. A top electrode 104 is disposed in an upper layer of the insulating film 103. The insulating film 103 and the top electrode 104 compose a membrane 105 which is vibrated upon driving the CMUT. In the drawings, the reference numerals 106 and 107 denote a lower surface of the membrane and an upper surface of the bottom electrode, respectively, and, the reference numerals 108 and 109 denote a semiconductor substrate and an insulating film, respectively.

When DC voltage and AC voltage are superimposed across the top electrode 104 and the bottom electrode 101, electrostatic force acts across the top electrode 104 and the bottom electrode 101 so that the membrane 105 is vibrated with a frequency of the applied AC voltage, thereby emitting ultrasonic waves.

In reverse, in the case of receiving ultrasonic waves, the membrane 105 is vibrated by the pressure of the ultrasonic waves reaching a surface of the membrane 105. Then, the distance between the top electrode 104 and the bottom electrode 101 is changed, so that the ultrasonic waves can be detected as a capacitance change.

It is clear from the above-described principle of operation that, in the case of transmitting ultrasonic waves, the larger a vibration amplitude of the membrane 105 is, the higher the generated ultrasonic pressure can be. Therefore, it is preferable to make the most of a thickness of the cavity portion 102 for vibrating the membrane 105. On the other hand, in the case of receiving ultrasonic waves, as the ultrasonic waves are detected by a capacitance change between the top electrode 104 and the bottom electrode 101, the narrower the distance of the top electrode 104 and the bottom electrode 101 is, the better the sensitivity is. Therefore, it is preferable that the thickness of the cavity portion 102 is small. In other words, high sound pressure transmission and high receiver sensitivity of ultrasonic waves are in an opposite relation with regard to the thickness of the cavity portion 102. Accordingly, to obtain desired sound pressure and sensitivity of ultrasonic waves, it is required to perform optimization of the thickness of the cavity portion 102. In this case, to obtain maximum transmitted sound pressure, a vibration amplitude of the membrane 105 can be an optimized thickness of the cavity portion 102.

However, when the lower surface 106 of the membrane 105 is even slightly contacted with the upper surface 107 of the bottom electrode 101 upon vibrating the membrane 105 (the state of FIG. 26B), a concentration of current to the insulating film 103 sandwiched by the top electrode 104 and the bottom electrode 101, an increase of the amount of injected current to the insulating film 103 due to a local temperature increase caused by the contact, or the like occurs, and therefore, the breakdown voltage of the insulating film 103 sandwiched by the top electrode 104 and the bottom electrode 101 is deteriorated in a contact region (the region surrounded by the fine dotted line) 110. Further, when the vibration of the membrane 105 is repeatedly performed and the lower surface 106 of the membrane 105 repeatedly contacts with the upper surface 107 of the bottom electrode 101, the breakdown voltage of the insulating film 103 is significantly deteriorated, and therefore, the breakdown voltage of the insulating film 103 becomes often lower than a driving voltage of the CMUT. In this case, dielectric breakdown of the insulating film 103 is possibly posed during driving of the CMUT, resulting in a cause of lowering reliability of long-term driving of the CMUT.

In order to ensure the long-term reliability, in the CMUT disclosed in Patent Document 1 or Patent Document 2 mentioned above, it is required to prevent the lower surface of the membrane from contacting with the upper surface of the bottom electrode by way of adjusting the DC voltage or AC voltage. Moreover, in consideration of manufacture variation of the CMUT, output fluctuation of the voltage source upon driving, or the like, it is required to set the driving voltage of the CMUT to a lower voltage than the maximum voltage that does not allow the lower surface of the membrane to contact with the upper surface of the bottom electrode by a way of providing a margin in order to prevent the lower surface of the membrane from contacting with the upper surface of the bottom electrode. Therefore, the maximum transmitted sound pressure becomes low.

In the above-mentioned Non-Patent Document 1, such a structure is described in which a post of an insulating film protruding above an upper surface of a bottom electrode is formed so that a membrane is not contacted with the bottom electrode. However, in this structure, as the post protrudes above the upper surface of the bottom electrode, vibration making the most of a thickness of a cavity portion cannot be generated, and therefore, the maximum transmitted sound pressure is lowered.

An object of the present invention is to provide a technique capable of achieving high transmitted sound pressure and high receiver sensitivity for a capacitive micromachined ultrasonic transducer (CMUT).

In addition, another object of the present invention is to provide a technique capable of improving reliability of long-term driving for a capacitive micromachined ultrasonic transducer (CMUT).

The above and other objects and novel characteristics of the present invention will be apparent from the description of the present specification and the accompanying drawings.

An embodiment of the inventions disclosed in the present application will be briefly described as follows.

The embodiment is an ultrasonic transducer including a bottom electrode, a first insulating film formed to cover the bottom electrode, a cavity portion formed on the first insulating film so as to overlap with the bottom electrode when viewed in plan view, a second insulating film formed to cover the cavity portion, and a top electrode formed on the second insulating film so as to overlap with the cavity portion when viewed in plan view. An opening portion is formed at a center portion of the top electrode, and, when viewed in plan view, the opening portion includes a region where the first insulating film and the second insulating film are contacted with each other therewithin when a potential difference between the bottom electrode and the top electrode is maximum upon driving the ultrasonic transducer.

The embodiment is a method of manufacturing an ultrasonic transducer. First, after forming a bottom electrode on a main surface of a semiconductor substrate, a first insulating film is formed to cover the bottom electrode. Then, after a sacrificial pattern is formed on the first insulating film so as to overlap with the bottom electrode when viewed in plan view, a second insulating film is formed to cover the sacrificial pattern. Further, after a top electrode having an opening portion at the center portion is formed so as to overlap with the sacrificial pattern when viewed in plan view, a third insulating film is formed to cover the top electrode. Then, an etching hole reaching the sacrificial pattern is formed in the second and third insulating films, and the sacrificial pattern is removed through the etching hole, thereby forming a cavity portion, and thereafter, a fourth insulating film is formed to cover the etching hole and the second insulating film. The opening portion formed in the top electrode is formed in the top electrode so as to include a region where the first insulating film and the second insulating film are contacted with each other therewithin when viewed in plan view when the top electrode is vibrated.

The effects obtained by the embodiment of the present invention disclosed in this application will be briefly described below.

High transmitted sound pressure and high receiver sensitivity can be achieved for a capacitive micromachined ultrasonic transducer (CMUT), and reliability of long-term driving can be improved.

### BRIEF DESCRIPTIONS OF THE DRAWINGS

FIG. 1 is a top view of a principal part of an ultrasonic element composing one ultrasonic transducer according to a first embodiment of the present invention;

FIG. 2A is a cross-sectional view of the principal part taken along the line A-A′ of FIG. 1 and FIG. 2B is a cross-sectional view of the principal part taken along the line B-B′ of FIG. 1;

FIG. 3 is a cross-sectional view of the principal part illustrating one aspect of a membrane vibrating upon driving the ultrasonic transducer according to the first embodiment of the present invention, the cross-sectional view of the principal part being taken along the line B-B′ of FIG. 1;

FIGS. 4A and 4B are cross-sectional views of a principal part for describing a method of manufacturing the ultrasonic element composing the ultrasonic transducer according to the first embodiment of the present invention, where FIG. 4A is a cross-sectional view of the principal part taken along the line A-A′ of FIG. 1 and FIG. 4B is a cross-sectional view of the principal part taken along the line B-B′ of FIG. 1;

FIGS. 5A and 5B are cross-sectional views of the principal part of the same portion of the ultrasonic element of FIGS. 4A and 4B during a process of manufacturing the ultrasonic element continued from FIGS. 4A and 4B;

FIGS. 6A and 6B are cross-sectional views of the principal part of the same portion of the ultrasonic element of FIGS. 4A and 4B during the process of manufacturing the ultrasonic element continued from FIGS. 5A and 5B;

FIGS. 7A and 7B are cross-sectional views of the principal part of the same portion of the ultrasonic element of FIGS. 4A and 4B during the process of manufacturing the ultrasonic element continued from FIGS. 6A and 6B;

FIGS. 8A and 8B are cross-sectional views of the principal part of the same portion of the ultrasonic element of FIGS. 4A and 4B during the process of manufacturing the ultrasonic element continued from FIGS. 7A and 7B;

FIGS. 9A and 9B are cross-sectional views of the principal part of the same portion of the ultrasonic element of FIGS. 4A and 4B during the process of manufacturing the ultrasonic element continued from FIGS. 8A and 8B;

FIGS. 10A and 10B are cross-sectional views of the principal part of the same portion of the ultrasonic element of FIGS. 4A and 4B during the process of manufacturing the ultrasonic element continued from FIGS. 9A and 9B;

FIGS. 11A and 11B are cross-sectional views of the principal part of the same portion of the ultrasonic element of FIGS. 4A and 4B during the process of manufacturing the ultrasonic element continued from FIGS. 10A and 10B;

FIGS. 12A and 12B are cross-sectional views of the principal part of the same portion of the ultrasonic element of FIGS. 4A and 4B during the process of manufacturing the ultrasonic element continued from FIGS. 11A and 11B;

FIGS. 13A and 13B are cross-sectional views of the principal part of the same portion of the ultrasonic element of FIGS. 4A and 4B during the process of manufacturing the ultrasonic element continued from FIGS. 12A and 12B;

FIGS. 14A and 14B are cross-sectional views of the principal part of the same portion of the ultrasonic element of FIGS. 4A and 4B during the process of manufacturing the ultrasonic element continued from FIGS. 13A and 13B;

FIG. 15 is a top view of a principal part of an ultrasonic element composing an ultrasonic transducer according to a second embodiment of the present invention;

FIG. 16A is a cross-sectional view of a principal part taken along the line C-C′ of FIG. 15 and FIG. 16B is a cross-sectional view of a principal part taken along the line D-D′ of FIG. 15;

FIG. 17 is a cross-sectional view of a principal part illustrating one aspect of a membrane vibrating upon driving the ultrasonic transducer according to the second embodiment of the present invention, the cross-sectional view of the principal part taken along the line D-D′ of FIG. 15;

FIGS. 18A and 18B are cross-sectional views of a principal part for describing a method of manufacturing the ultrasonic element composing the ultrasonic transducer according to the second embodiment of the present invention, where FIG. 18A is a cross-sectional view of the principal part taken along the line C-C′ of FIG. 15 and FIG. 18B is a cross-sectional view of the principal part taken along the line D-D′ of FIG. 15;

FIGS. 19A and 19B are cross-sectional views of the principal part of the same portion of the ultrasonic element of FIGS. 18A and 18B during a process of manufacturing the ultrasonic element continued from FIGS. 18A and 18B;

FIGS. 20A and 20B are cross-sectional views of the principal part of the same portion of the ultrasonic element of FIGS. 18A and 18B during the process of manufacturing the ultrasonic element continued from FIGS. 19A and 19B;

FIGS. 21A and 21B are cross-sectional views of the principal part of the same portion of the ultrasonic element of FIGS. 18A and 18B during the process of manufacturing the ultrasonic element continued from FIGS. 20A and 20B;

FIGS. 22A and 22B are cross-sectional views of the principal part of the same portion of the ultrasonic element of FIGS. 18A and 18B during the process of manufacturing the ultrasonic element continued from FIGS. 21A and 21B;

FIG. 23 is a top view of a principal part of an ultrasonic element composing an ultrasonic transducer according to a third embodiment of the present invention;

FIG. 24A is a cross-sectional view of a principal part taken along the line E-E′ of FIG. 23 and FIG. 24B is a cross-sectional view of a principal part taken along the line F-F′ of FIG. 23;

FIG. 25 is a cross-sectional view of a principal part illustrating one aspect of a membrane vibrating upon driving the ultrasonic transducer according to the third embodiment of the present invention, the cross-sectional view of the principal part taken along the line F-F′ of FIG. 23; and

FIGS. 26A and 26B are cross-sectional views of a principal part of an ultrasonic transducer which has been studied by the inventors of the present invention.

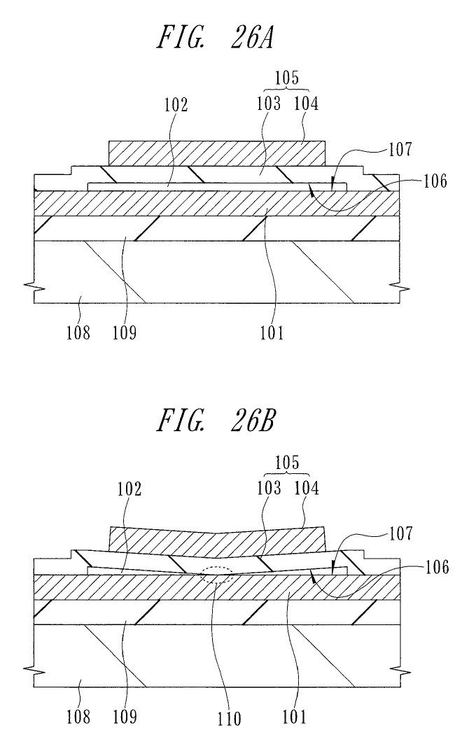

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable. Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range mentioned above.

Also, in some drawings used in the embodiments, hatching is used even in a plan view so as to make the drawings easy to see. In addition, in the following embodiments, the term “wafer” mainly indicates a Si (silicon) single-crystal wafer and it indicates not only the same but also a SOI (Silicon On Insulator) wafer, an insulating film substrate for forming an integrated circuit thereon, or the like. The shape of the wafer includes not only a circular shape or a substantially circular shape but also a square shape, a rectangular shape, and the like.

Moreover, components having the same function are denoted by the same reference symbols throughout the drawings for describing the embodiment, and the repetitive description thereof will be omitted. Hereinafter, embodiments of the present invention will be described in detail with reference to the accompanying drawings.

### First Embodiment

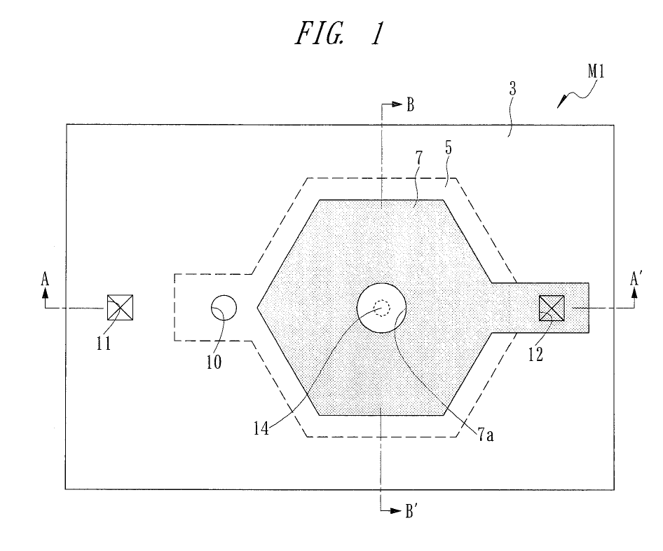

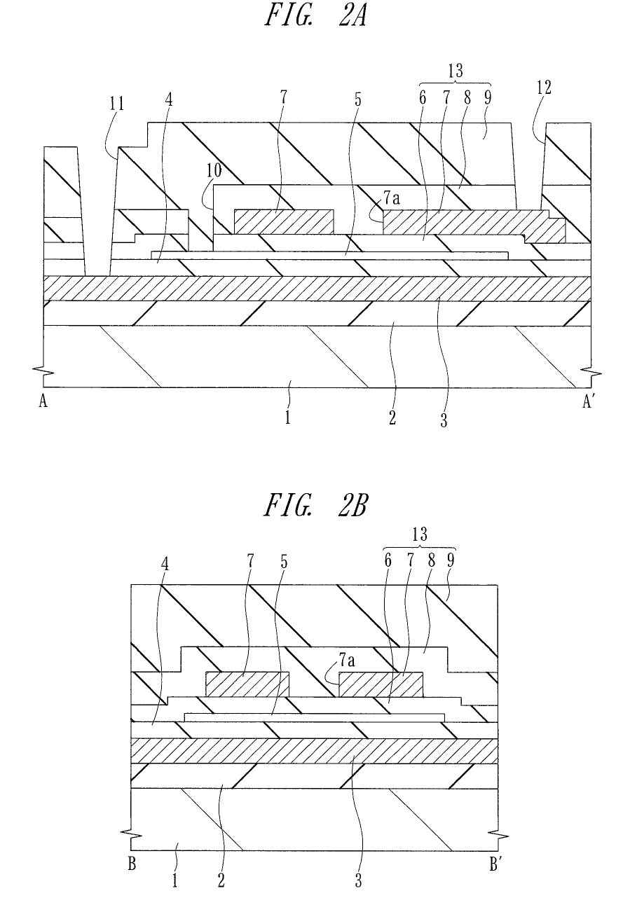

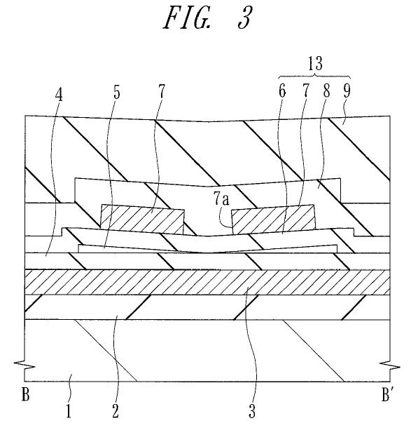

An ultrasonic element composing a CMUT according to a first embodiment will be described with reference to FIG. 1 to FIG. 3. FIG. 1 is a top view of a principal part of an ultrasonic element composing the CMUT, FIG. 2A is a cross-sectional view of the principal part taken along the line A-A′ of FIG. 1, and FIG. 2B is a cross-sectional view of the principal part taken along the line B-B′ of FIG. 1. Also, FIG. 3 is a cross-sectional view of a principal part illustrating an aspect of a membrane vibrating upon driving the CMUT, the cross-sectional view of the principal part being taken along the line B-B′ of FIG. 1.

As illustrated in FIGS. 1 to 2B, a bottom electrode (first electrode) 3 of an ultrasonic element M1 is formed in an upper layer of an insulating film 2 formed on a main surface of a semiconductor substrate 1. A cavity portion 5 is formed in an upper layer of the bottom electrode 3 interposing a first insulating film 4. A shape of the cavity portion 5 viewed from above is hexagonal, and a length of one side thereof is, for example, about 20 to 30 μm. Further, a second insulating film 6 is formed to surround the cavity portion 5, and a top electrode (second electrode) 7 is formed in an upper layer of the second insulating film 6. A shape of the top electrode 7 viewed from above is hexagonal along the shape of the cavity portion 5, and, at the center portion of the top electrode 7, an opening portion 7a having a diameter of, for example, about 10 μm is provided. A third insulating film 8 and a fourth insulating film 9 are sequentially formed in an upper layer of the top electrode 7.

In addition, an etching hole 10 penetrating through the second insulating film 6 and the third insulating film 8 is formed at a leading portion of the hexagonal cavity portion 5. The etching hole 10 is provided for forming the cavity portion 5, and after the cavity portion 5 is formed, the etching hole 10 is filled with the fourth insulating film 9. A pad opening portion 11 reaching the bottom electrode 3 is formed in the first, second, third, and fourth insulating films 4, 6, 8, and 9 in a region where the cavity portion 5 and the top electrode 7 are not formed, so that voltage can be supplied to the bottom electrode 3 via the pad opening portion 11. Further, a pad opening portion 12 reaching the top electrode 7 is formed in the third and fourth insulting films 8 and 9 on the top electrode 7, so that voltage can be supplied to the top electrode 7 via the pad opening portion 12. A membrane 13 to be vibrated upon driving the CMUT is composed of the second insulating film 6, the third insulating film 8, the fourth insulating film 9, and the top electrode 7.

In the ultrasonic element M1, the cavity portion 5 has a hexagonal shape when viewed in plan view as described above. Therefore, if DC voltage and AC voltage are supplied across the top electrode 7 and the bottom electrode 3, a maximum displacement point of the vibration of the membrane 13 is the center point of the hexagon. Therefore, a point where a lower surface of the membrane 13 (lower surface of the second insulating film 6) is to be in contact with the first insulating film 4 covering an upper surface of the bottom electrode 3 is, first, the center point of the hexagonal cavity portion 5, and the contact point becomes a contact region (region surrounded by the relatively fine dotted line) 14 spreading towards the outer peripheral portion from the center point of the cavity portion 5 together with increase of the potential difference between the top electrode 7 and the bottom electrode 3, and the area of the contact region 14 is maximum when the potential difference is maximum. The above-described opening portion 7a formed at the center portion of the top electrode 7 is provided to include the contact region 14 having the maximum area therewithin when viewed in plan view.

FIG. 3 is a diagram illustrating a moment at which the lower surface of the second insulating film 6 covering the lower surface of the top electrode 7 is contacted with the upper surface of the first insulating film 4 covering the upper surface of the bottom electrode 3 by the vibration of the membrane 3, and the area of the contact region 14 is maximum. As the opening portion 7a is formed at the center portion of the top electrode 7, even when the membrane 13 is vibrated by a voltage allowing the lower surface of the second insulating film 6 to contact with the upper surface of the first insulating film 4 upon driving the CMUT, the first and second insulating films 4 and 6 are not sandwiched by the top electrode 7 and the bottom electrode 3 in the contact region 14. In this manner, current does not readily flow in the contact region 14 and thus deterioration of the breakdown voltage of the first and second insulating films 4 and 6 can be suppressed.

In other words, if the opening portion 7a is not formed at the center portion of the top electrode 7, the structure has the first and second insulating films 4 and 6 being sandwiched by the top electrode 7 and the bottom electrode 3 in the contact region 14, so that current flows in the first and second insulating films 4 and 6 in the contact region 14, and thus the breakdown voltage of the first and second insulating films 4 and 6 is deteriorated. However, in the first embodiment, the structure is made such that the opening portion 7a including the contact region 14 having the maximum area therewithin when viewed in plan view is provided to the top electrode 7 so that the first and second insulating films 4 and 6 are not sandwiched by the top electrode 7 and the bottom electrode 3 in the contact region 14 even when the membrane 13 is vibrated, and thus, current does not flow in the first and second insulating films 4 and 6 in the contact region 14, thereby suppressing deterioration of the breakdown voltage of the first and second insulating films 4 and 6.

As deterioration of the breakdown voltage of the first and second insulating films 4 and 6 can be suppressed, the vibration amplitude of the membrane 13 can be a thickness of the cavity portion 5 provided between the first and second insulating films 4 and 6, thereby enabling the vibration of the membrane 13 making the most of the thickness of the cavity portion 5. As a result, when optimization of the thickness of the cavity portion 5 is made to obtain desired transmitted sound pressure and receiver sensitivity, the maximum transmitted sound pressure can be obtained by setting the vibration amplitude of the membrane 13 to be the optimized thickness of the cavity portion 5, thereby achieving high transmitted sound pressure and high receiver sensitivity of the CMUT. In addition, deterioration of the breakdown voltage of the first and second insulating films 4 and 6 can be suppressed, thereby improving the reliability of long-term operation of the CMUT.

The area of the opening portion 7a provided at the center portion of the top electrode 7 is preferably about three times the area of the contact region 14 when viewed in plan view. That is, the inner wall of the opening portion 7a is preferably away from the outer rim of the contact region 14 by about a width of the contact region 14 when viewed in plan view.

Also, it is considered that, when the opening portion 7a is provided, the overlapped area of the top electrode 7 and the bottom electrode 3 viewed from above is small and the electric capacitance change upon receiving is small. However, when the area of the opening portion 7a is about three times the area of the contact region 14, reduction of the overlapped area of the top electrode 7 and the bottom electrode 3 can be at a negligible level.

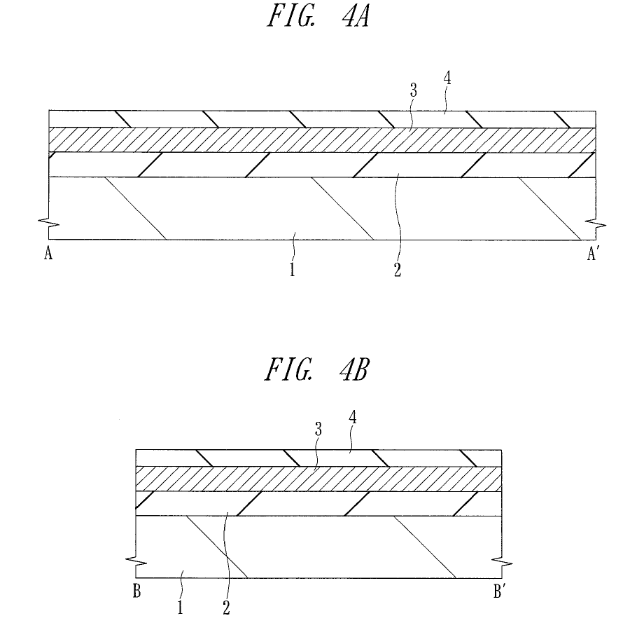

Next, a method of manufacturing the ultrasonic element composing the CMUT according to the first embodiment will be sequentially described with reference to FIGS. 4A to 13B. Drawings attached with “A” of FIGS. 4A to 13B are cross-sectional views of principal parts taken along the line A-A′ of FIG. 1, and those attached with “B” are cross-sectional views of principal parts taken along the line B-B′ of FIG. 1.

First, as illustrated in FIGS. 4A and 4B, the insulating film 2 made of a silicon oxide film is formed on the semiconductor substrate 1, and further, a titanium nitride film, an aluminum alloy film, and another titanium nitride film are sequentially formed on the insulating film 2 to form the bottom electrode 3 having a multilayered structure. A thickness of the insulating film 2 is, e.g., 400 nm, and thicknesses of the lower titanium nitride film, aluminum alloy film, and upper titanium nitride film composing the bottom electrode 3 are, e.g., 50 nm, 600 nm, and 50 nm, respectively. Subsequently, the first insulating film 4 made of a silicon oxide film is deposited on the bottom electrode 3 by using, for example, plasma CVD (Chemical Vapor Deposition) method. A thickness of the first insulating film 4 is, e.g., 200 nm.

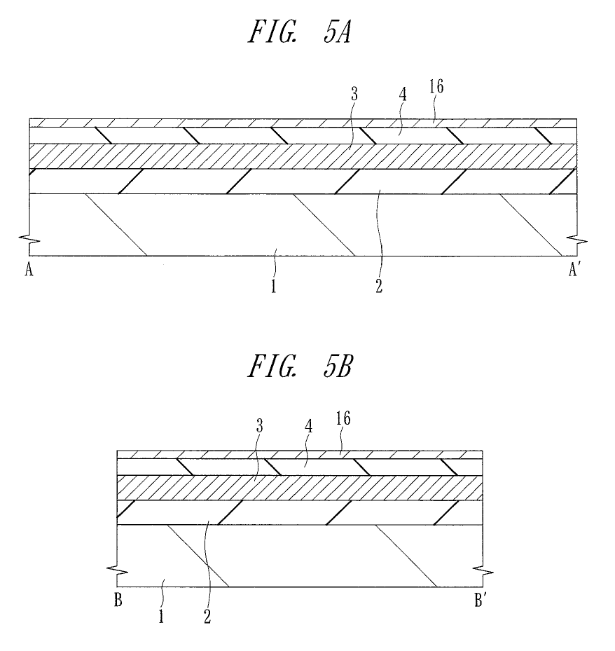

Next, as illustrated in FIGS. 5A and 5B, an amorphous silicon film 16 is deposited on the first insulating film 4 by using, for example, plasma CVD method. A thickness of the amorphous silicon film 16 is, e.g., 100 nm.

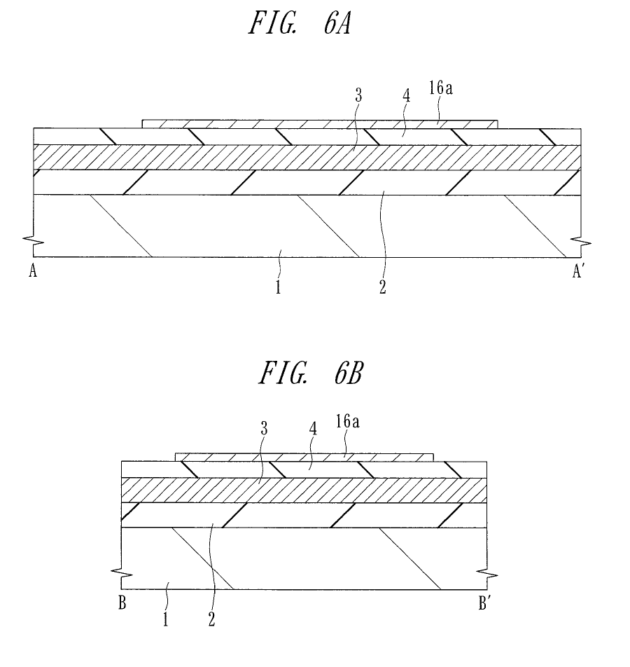

Next, as illustrated in FIGS. 6A and 6B, the amorphous silicon film 16 is processed using photolithography technique and dry etching technique to form a sacrificial pattern 16a. The sacrificial pattern 16a will be removed in a later step, and the cavity portion 5 will be formed at the portion where the sacrificial pattern 16a is removed.

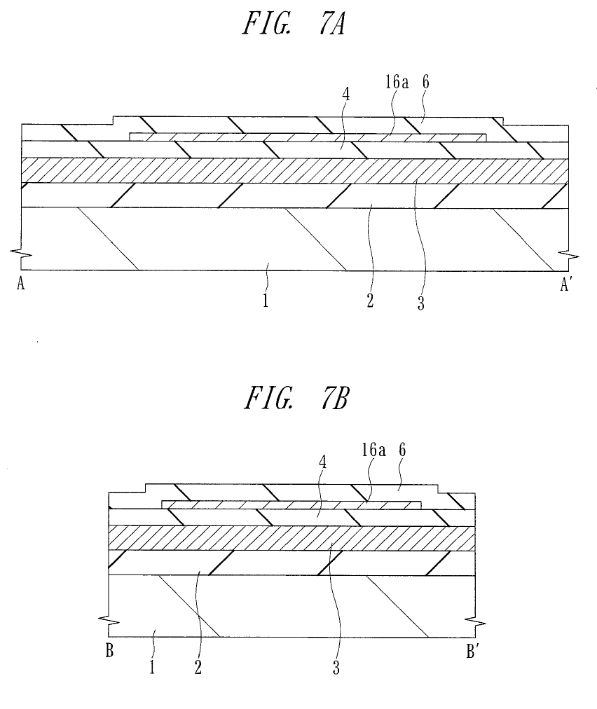

Next, as illustrated in FIGS. 7A and 7B, the second insulating film 6 made of a silicon oxide film is deposited to cover the sacrificial pattern 16a by using, for example, plasma CVD method. A thickness of the second insulating film 6 is 200 nm.

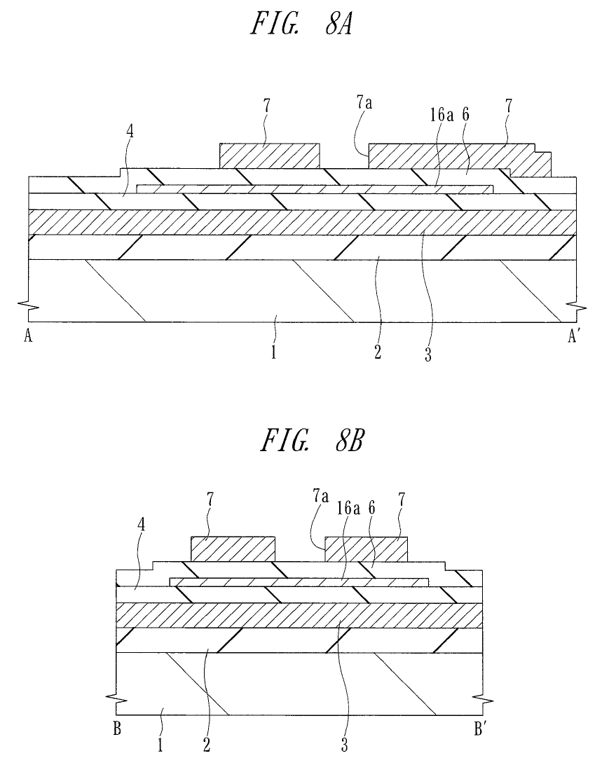

Next, as illustrated in FIGS. 8A and 8B, a titanium nitride film, an aluminum alloy film, and another titanium nitride film are sequentially deposited on the second insulating film 6 by using, for example, sputtering method to form the multilayered film. Subsequently, the top electrode 7 is formed by processing the multilayered film by using photolithography technique and dry etching technique. Thicknesses of the lower titanium nitride film, aluminum alloy film, and upper titanium nitride film composing the top electrode 7 are, e.g., 50 nm, 300 nm, and 50 nm, respectively. At this time, the opening portion 7a is simultaneously formed to the top electrode 7.

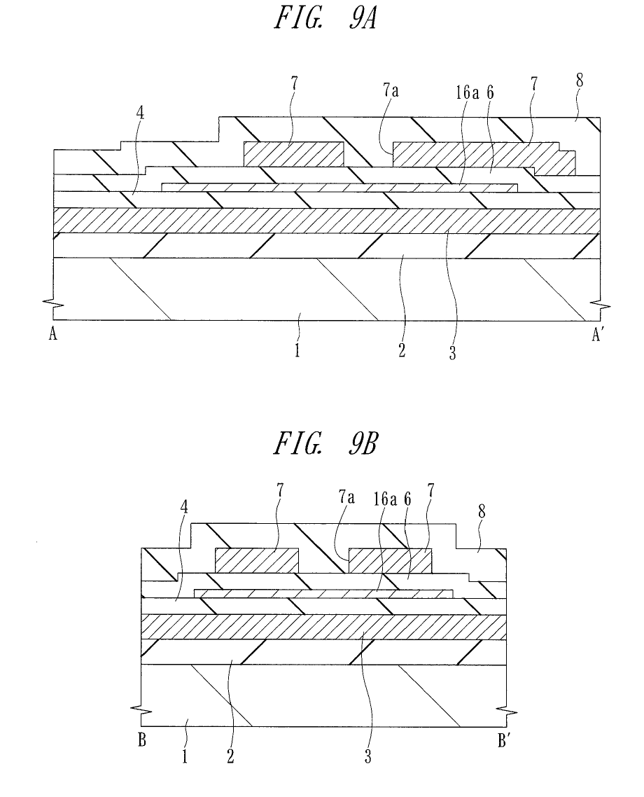

Next, as illustrated in FIGS. 9A and 9B, the third insulating film 8 made of a silicon nitride film is deposited to cover the top electrode 7 by using, for example, plasma CVD method. A thickness of the third insulating film 8 is, e.g., 300 nm. At this time, the inside of the opening portion 7a provided to the top electrode 7 is also filled with the third insulating film 8.

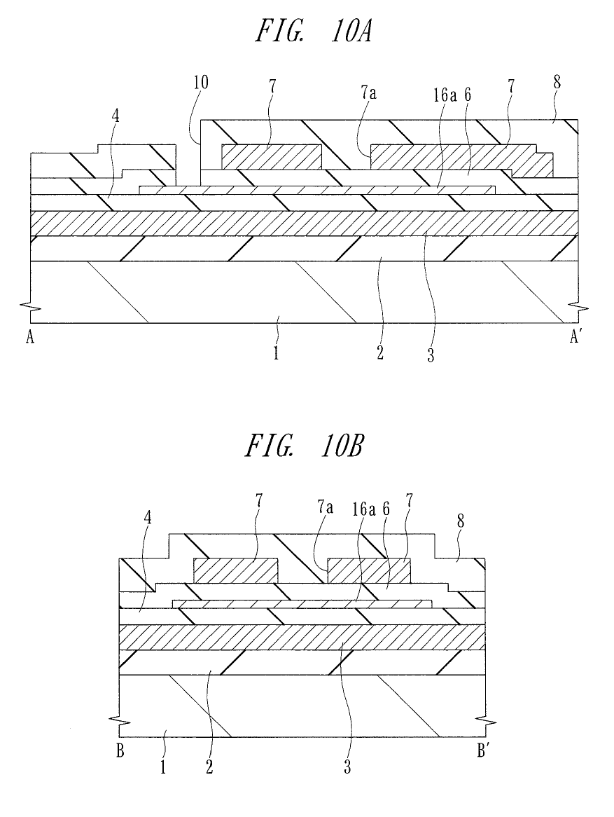

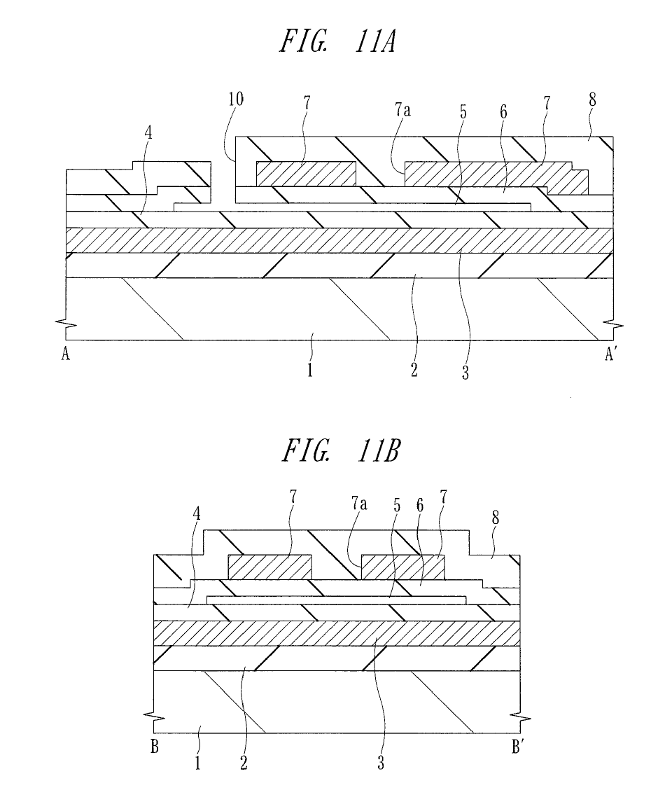

Next, as illustrated in FIGS. 10A and 10B, the etching hole 10 reaching the sacrificial pattern 16a is formed by processing the second and third insulating films 6 and 8 by using photolithography technique and dry etching technique. Then, as illustrated in FIGS. 11A and 11B, the sacrificial pattern 16a is etched by xenon fluoride gas (XeF₂) through the etching hole 10 to form the cavity portion 5 at the portion where the sacrificial pattern 16a is removed.

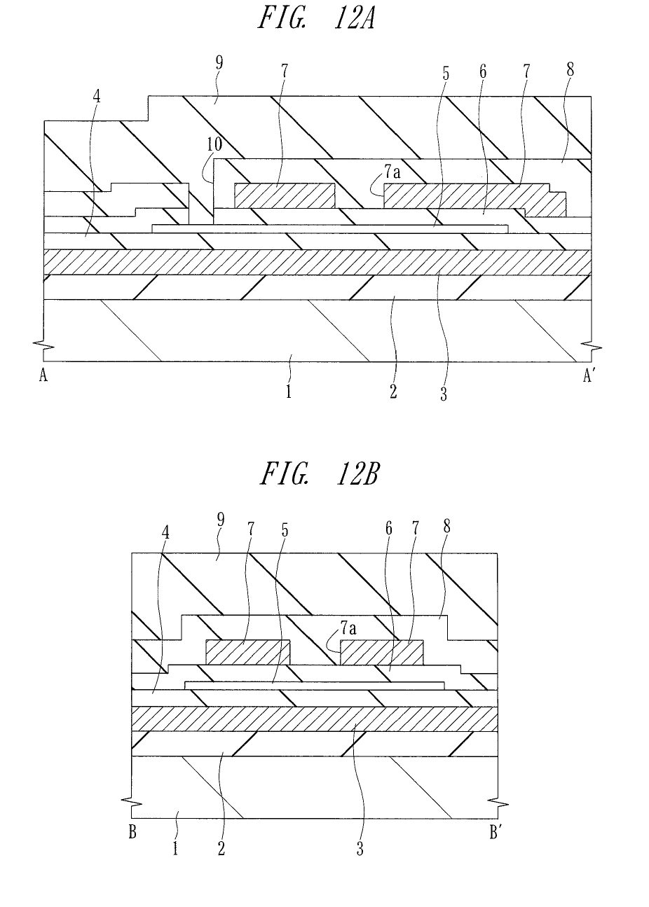

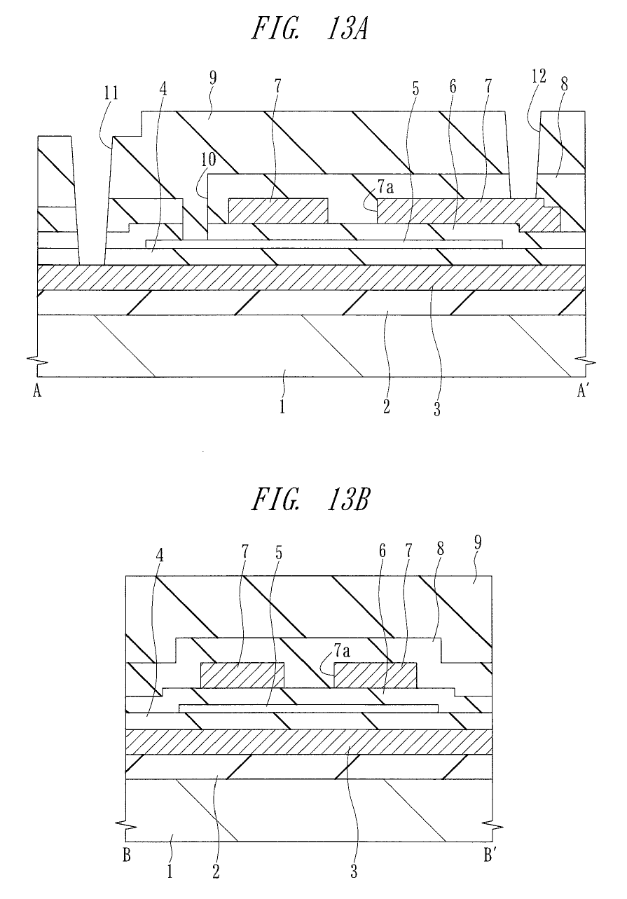

Next, as illustrated in FIGS. 12A and 12B, the fourth insulating film 9 made of a silicon nitride film is deposited to bury within the etching hole 10 by using, for example, plasma CVD method. A thickness of the fourth insulating film 9 is, e.g., 800 nm. Subsequently, as illustrated in FIGS. 13A and 13B, by using photolithography technique and dry etching technique, the first, second, third, and fourth insulating films 4, 6, 8, and 9 are processed to form the pad opening portion 11 reaching the bottom electrode 3, and the third and fourth insulating films 8 and 9 are processed to form the pad opening portion 12 reaching the top electrode 7. According to the above-described manufacturing process, the ultrasonic element M1 composing the CMUT of the first embodiment is substantially completed.

Note that, while the cavity portion 5 of the ultrasonic element M1 has a hexagonal shape when viewed in plan view in FIG. 1 described above, the shape is not limited to this and it can be any arbitral shape. Also in this case, the opening portion 7a including the contact region 14 therewithin when viewed in plan view can be provided to the top electrode 7, the contact region 14 being a region where the lower surface of the membrane 13 (lower surface of the second insulating film 6 covering the lower surface of the top electrode 7) is contacted with the first insulating film 4 covering the upper surface of the bottom electrode 3 by the vibration of the membrane 13.

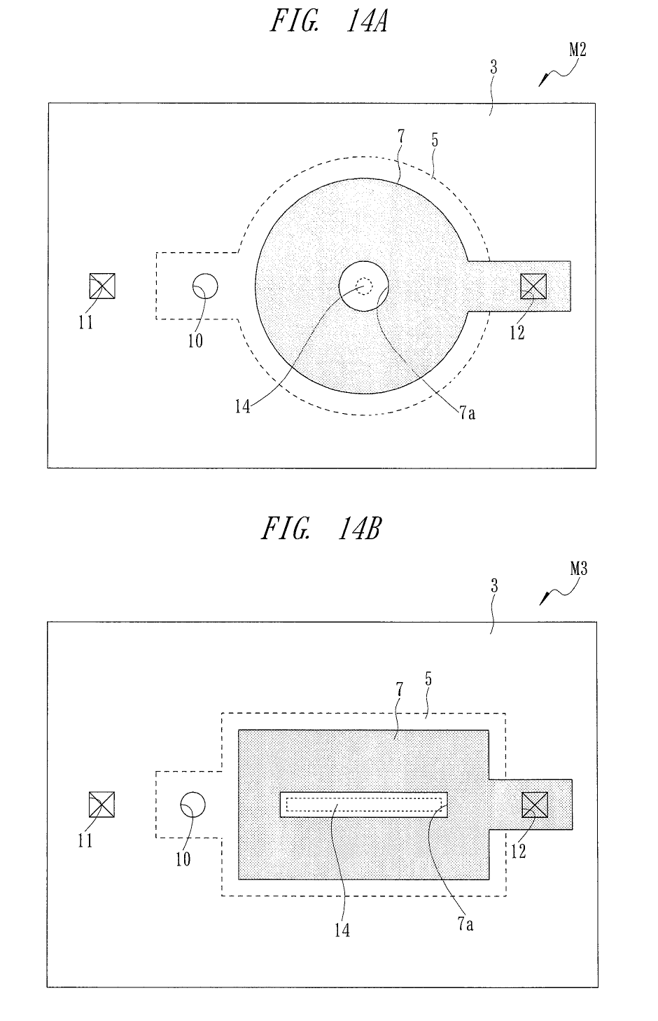

FIGS. 14A and 14B illustrate a plan view of a principal part of an ultrasonic element according to the first embodiment having the cavity portion in a circular shape, and a plan view of a principal part of an ultrasonic element according to the first embodiment having the cavity portion in a rectangular shape, respectively.

In an ultrasonic element M2 having the cavity portion 5 in a circular shape illustrated in FIG. 14A, the contact region 14 formed by the vibration of the membrane 13 is positioned at the center portion of the circle similar to the case of the cavity portion 5 in a hexagonal shape. Therefore, the same effects with the case of cavity portion 5 in a hexagonal shape can be obtained when the opening portion 7a including the contact region 14 therewithin at the center portion of the top electrode 7 when viewed in plan view is provided.

In an ultrasonic element M3 having the cavity portion 5 in a rectangular shape illustrated in FIG. 14B, the contact region 14 formed by the vibration of the membrane 13 is positioned at the center portion of the rectangle along the shape of the top electrode 7. Therefore, the same effects with the case of the cavity portion 5 in a hexagonal or circular shape can be obtained when the opening portion 7a including the contact region 14 therewithin when viewed in plan view is provided to the top electrode 7.

In addition, materials composing the ultrasonic element M1 of the CMUT described in the first embodiment have been described as one of combinations, and materials having conductivity such as tungsten or others can be used as the materials of the top electrode 7 or the bottom electrode 3. Also, a material of the sacrificial pattern 16a can be a material capable of ensuring etching selectivity with the insulating films surrounding the periphery of the sacrificial pattern 16a (e.g., the first and second insulating films 4 and 6). Therefore, it can be an SOG film (Spin on Glass) or the like instead of the above-described amorphous silicon film 16. When the sacrificial pattern 16a is an SOG film, the etching selectivity with the insulating films surrounding the sacrificial pattern 16a can be ensured by using hydrofluoric acid for etching.

Further, since the CMUT can be manufactured on a planarized surface in the above-described manufacturing method of the ultrasonic element M1 of the CMUT according to the first embodiment, the bottom electrode 3 can be composed of a silicon substrate (semiconductor substrate 1), and, the bottom electrode 3 can be composed of a part of wiring portions of an LSI.

In this manner, according to the first embodiment, deterioration of the withstand voltage of the first and second insulating films 4 and 6 between the top electrode 7 and the bottom electrode 3 can be suppressed. Consequently, the amplitude of the vibration of the membrane 13 can be the thickness of the cavity portion 5 provided between the first insulating film 4 and the second insulating film 6, so that the vibration of the membrane 13 by making the most of the thickness of the cavity portion 5 can be achieved. As a result, if optimization of the thickness of the cavity portion 5 is performed to obtain desired transmitted sound pressure and receiver sensitivity, the maximum transmitted sound pressure can be obtained by setting the vibration amplitude of the membrane 13 to be the optimized thickness of the cavity portion 5, thereby achieving high transmitted sound pressure and high receiver sensitivity of the CMUT. Moreover, reliability of long-term operation of the CMUT can be improved.

### Second Embodiment

A CMUT according to a second embodiment is similar to that of the above-described first embodiment, and has a structure in which, even when the membrane 13 is vibrated, the first and second insulating films 4 and 6 are not sandwiched by the top electrode 7 and the bottom electrode 3 in the contact region 14 where the second insulating film 6 covering the lower surface of the top electrode 7 and the first insulating film 4 covering the upper surface of the bottom electrode 3 are contacted with each other. A different point of the second embodiment from the first embodiment is that an opening portion 3a is provided to the bottom electrode 3 without providing the opening portion 7a to the top electrode 7.

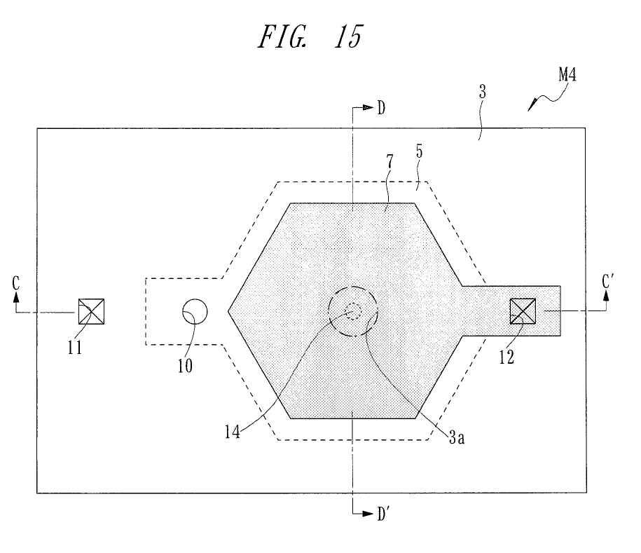

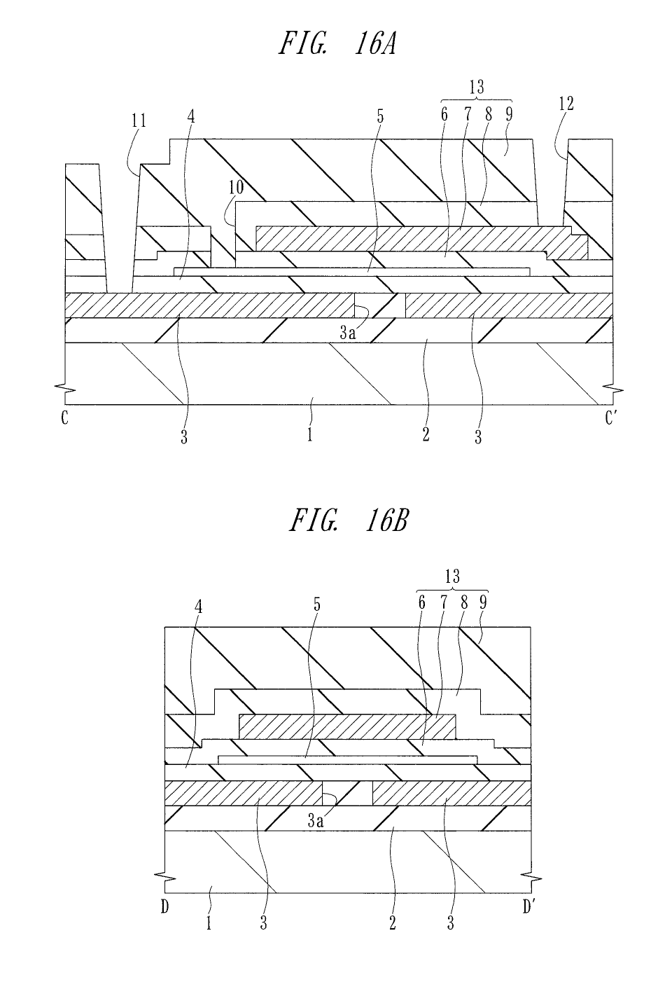

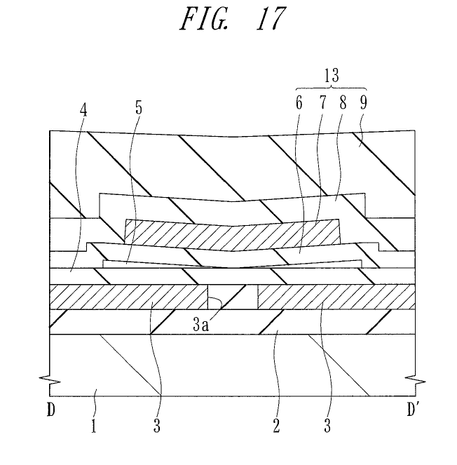

An ultrasonic element composing a CMUT according to the second embodiment will be described with reference to FIGS. 15 to 17. FIG. 15 is a top view of a principal part of one ultrasonic element composing the CMUT, FIG. 16A is a cross-sectional view of the principal part taken along the line C-C′ of FIG. 15, and FIG. 16B is a cross-sectional view of the principal part taken along the line D-D′ of FIG. 15. And, FIG. 17 is a cross-sectional view of the principal part illustrating one aspect of a membrane vibrating upon driving the CMUT, the cross-sectional view of the principal part taken along the line D-D′ of FIG. 15.

As illustrated in FIGS. 15 and 16A-16B, the bottom electrode 3 of an ultrasonic element M4 is formed in an upper layer of the insulating film 2 formed on the main surface of the semiconductor substrate 1, and the opening portion 3a having a diameter of, e.g., about 10 μm is provided to the bottom electrode 3. The cavity portion 5 is formed in the upper layer of the bottom electrode 3 interposing the first insulating film 4. The shape of the cavity portion 5 viewed from above is hexagonal, and a length of one side thereof is, e.g., about 20 to 30 μm. The opening portion 3a provided to the bottom electrode 3 is provided to be positioned at the center portion of the cavity portion 5 when viewed in plan view. In addition, the second insulating film 6 is formed to surround the cavity portion 5, and the top electrode 7 is formed in an upper layer of the second insulating film 6. The shape of the top electrode 7 viewed from above is hexagonal along the shape of the cavity portion 5. The third insulating film 8 and the fourth insulating film 9 are sequentially formed in an upper layer of the top electrode 7.

In addition, the etching hole 10 penetrating through the second insulating film 6 and the third insulating film 8 is formed at a leading portion of the hexagonal cavity portion 5. The etching hole 10 is provided for forming the cavity portion 5, and after the cavity portion 5 is formed, the etching hole 10 is filled with the fourth insulating film 9. The pad opening portion 11 reaching the bottom electrode 3 is formed in the first, second, third, and fourth insulating films 4, 6, 8, and 9 in a region where the cavity portion 5 and the top electrode 7 are not formed, so that voltage can be supplied to the bottom electrode 3 via the pad opening portion 11. Further, the pad opening portion 12 reaching the top electrode 7 is formed in the third and fourth insulting films 8 and 9 on the top electrode 7, so that voltage can be supplied to the top electrode 7 via the pad opening portion 12. The membrane 13 to be vibrated upon driving the CMUT is composed of the second insulating film 6, the third insulating film 8, the fourth insulating film 9, and the top electrode 7.

Similar to the first embodiment described above, in the ultrasonic element M4, the cavity portion 5 has a hexagonal shape when viewed in plan view. Therefore, if DC voltage and AC voltage are supplied across the top electrode 7 and the bottom electrode 3, a maximum displacement point of the vibration of the membrane 13 is the center point of the hexagon. Therefore, a point where the lower surface of the membrane 13 (lower surface of the second insulating film 6) is to be in contact with the first insulating film 4 covering the upper surface of the bottom electrode 3 is, first, the center point of the hexagonal cavity portion 5, and the contact point becomes a contact region 14 spreading towards the outer peripheral portion from the center point of the cavity portion 5 together with increase of the potential difference between the top electrode 7 and the bottom electrode 3, and the area of the contact region 14 is maximum when the potential difference is maximum. The above-described opening portion 3a formed at the center portion of the bottom electrode 3 is provided to include the contact region 14 having the maximum area therewithin when viewed in plan view.

FIG. 17 is a diagram illustrating a moment at which the lower surface of the second insulating film 6 covering the lower surface of the top electrode 7 is contacted with the upper surface of the first insulating film 4 covering the upper surface of the bottom electrode 3 by the vibration of the membrane 13, and the area of the contact region 14 is maximum. As the opening portion 3a is formed at the center portion of the bottom electrode 3, even when the membrane 13 is vibrated by a voltage allowing the lower surface of the second insulating film 6 to be contacted with the upper surface of the first insulating film 4 upon driving the CMUT, the first and second insulating films 4 and 6 are not sandwiched by the top electrode 7 and the bottom electrode 3 in the contact region 14. In this manner, current does not readily flow in the contact region 14, and thus deterioration of the breakdown voltage of the first and second insulating films 4 and 6 can be suppressed.

In other words, if the opening portion 3a is not formed at the center portion of the bottom electrode 3, the structure has the first and second insulating films 4 and 6 being sandwiched by the top electrode 7 and the bottom electrode 3 in the contact region 14, so that current flows in the first and second insulating films 4 and 6 in the contact region 14, and thus the breakdown voltage of the first and second insulating films 4 and 6 is deteriorated. However, in the second embodiment, the structure is made such that the opening portion 3a including the contact region 14 having the maximum area when viewed in plan view is provided to the bottom electrode 3, so that the first and second insulating films 4 and 6 are not sandwiched by the top electrode 7 and the bottom electrode 3 in the contact region 14 even when the membrane 13 is vibrated, and thus current does not flow in the first and second insulating films 4 and 6 in the contact region 14, thereby suppressing deterioration of the breakdown voltage of the first and second insulating films 4 and 6. As a result, effects similar to those of the first embodiment can be obtained.

The area of the opening portion 3a provided at the center portion of the bottom electrode 3 is preferably about three times the area of the contact region 14 when viewed in plan view. That is, the inner wall of the opening portion 3a is preferably away from the outer rim of the contact region 14 by about a width of the contact region 14.

Also, it is considered that, when the opening portion 3a is provided, the overlapped area of the top electrode 7 and the bottom electrode 3 viewed from above is small, so that the electric capacitance change upon receiving is small. However, when the area of the opening portion 3a is about three times the area of the contact region 14, reduction of the overlapped area of the top electrode 7 and the bottom electrode 3 can be at a negligible level.

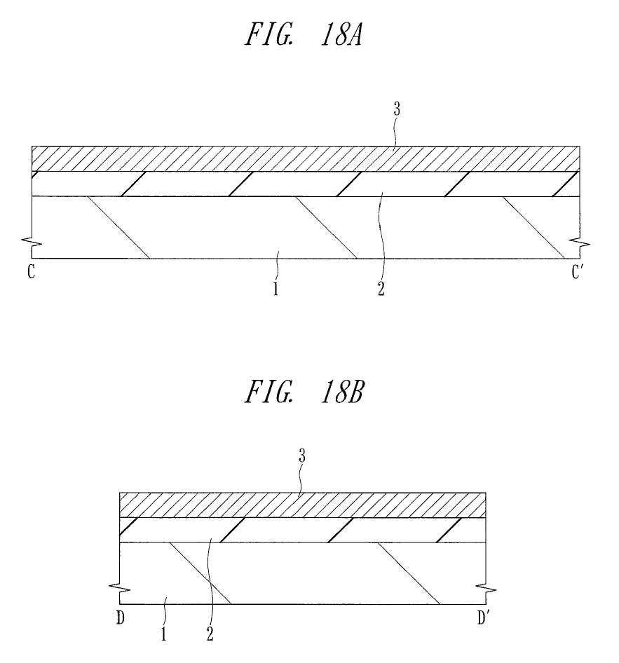

Next, a method of manufacturing the ultrasonic element composing the CMUT according to the second embodiment will be sequentially described with reference to FIGS. 18A to 21B. Drawings attached with “A” of FIGS. 18A to 21B are cross-sectional views of principal parts taken along the line C-C′ of FIG. 15, and those attached with “B” are cross-sectional views of principal parts taken along the line D-D′ of FIG. 15.

First, as illustrated in FIGS. 18A and 18B, the insulating film 2 made of a silicon oxide film is formed on the semiconductor substrate 1, and further, a titanium nitride film, an aluminum alloy film, and another titanium nitride film are sequentially formed on the insulating film 2 to form the bottom electrode 3 having a multilayered structure. A thickness of the insulating film 2 is, e.g., 400 nm, and thicknesses of the lower titanium nitride film, aluminum alloy film, and upper titanium nitride film composing the bottom electrode 3 are, e.g., 50 nm, 600 nm, and 50 nm, respectively.

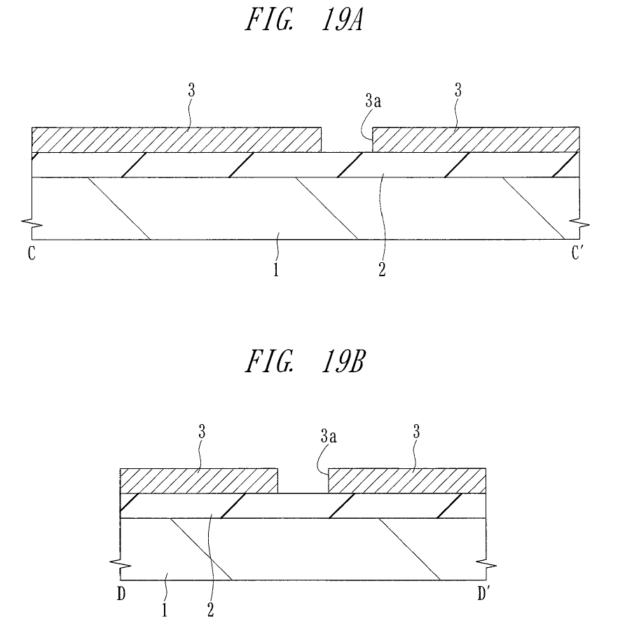

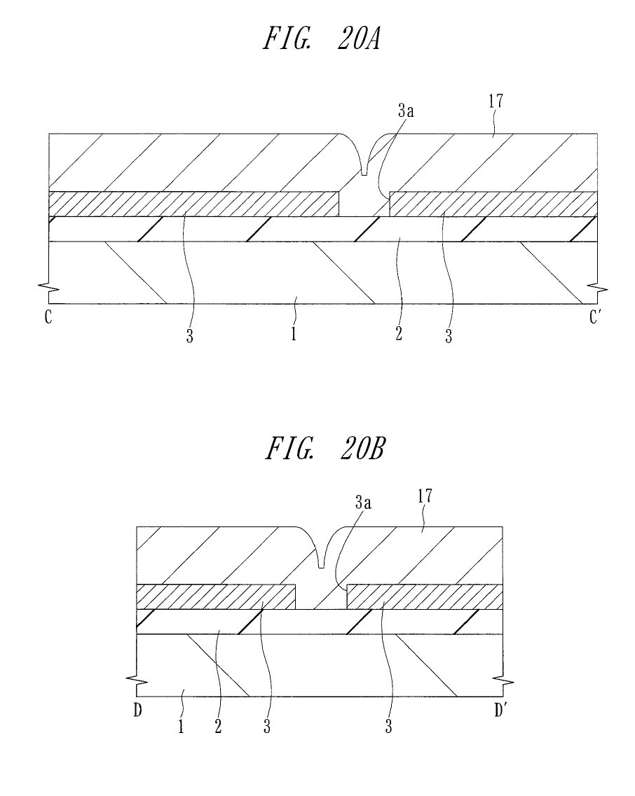

Next, as illustrated in FIGS. 19A and 19B, the opening portion 3a is formed by processing the bottom electrode 3 by using photolithography technique and dry etching technique. Subsequently, as illustrated in FIGS. 20A and 20B, a fifth insulating film 17 made of a silicon oxide film is deposited on the bottom electrode 3 by using, for example, plasma CVD (Chemical Vapor Deposition) method. A thickness of the fifth insulating film 17 is, e.g., 1200 nm. At this time, the inside of the opening portion 3a provided to the bottom electrode 3 is also filled with the fifth insulating film 17.

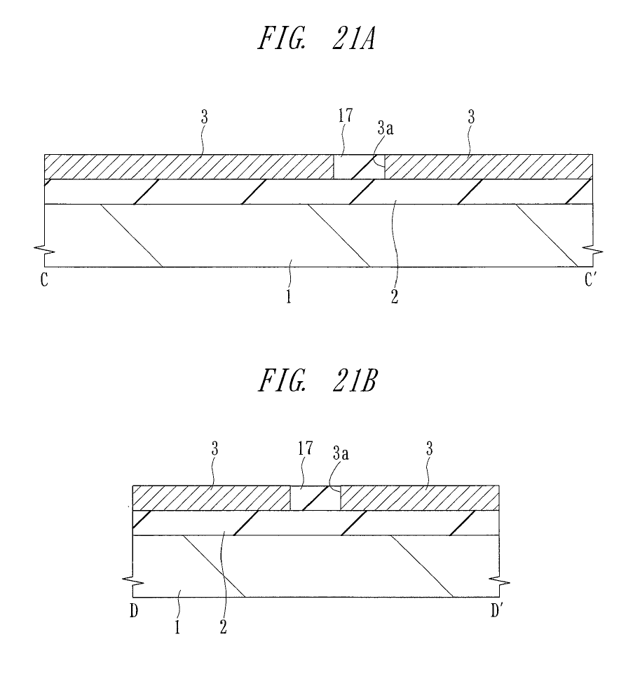

Next, as illustrated in FIGS. 21A and 21B, the fifth insulating film 17 is planarized to expose the upper surface of the bottom electrode 3 by using CMP (Chemical Mechanical Polishing) method. In this case, the planarization can be performed by a combination of CMP technique and dry etching technique. As the subsequent manufacturing process is similar to that of the first embodiment described above (FIGS. 4 to 13B), descriptions thereof will be omitted. Meanwhile, the opening portion 7a is formed to the top electrode 7 at the same time of forming the top electrode 7 in the above-described first embodiment, but the opening portion 7a is not formed to the top electrode 7 in the second embodiment. The ultrasonic element M4 composing the CMUT according to the second embodiment is substantially completed by the above-described manufacturing process.

In the second embodiment, a step of filling the inside of the opening portion 3a formed to the bottom electrode 3 with the fifth insulating film 17 is added as compared with the above-described first embodiment. However, since the opening portion 7a is not provided to the top electrode 7 composing the membrane 13, there is an advantage of not having an influence of distortion of the top electrode 7 on the membrane 13 due to formation of the opening portion 7a to the top electrode 7.

Note that, in the second embodiment, while the cavity portion 5 of the ultrasonic element M4 has a hexagonal shape when viewed in plan view in FIG. 15 described above, the shape is not limited to this and it can be any arbitral shape. Also in this case, the opening portion 3a including the contact region 14 therewithin when viewed in plan view can be provided to the bottom electrode 3, the contact region 14 being a region where the lower surface of the membrane 13 (lower surface of the second insulating film 6 covering the lower surface of the top electrode 7) is contacted with the first insulating film 4 covering the upper surface of the bottom electrode 3 by the vibration of the membrane 13.

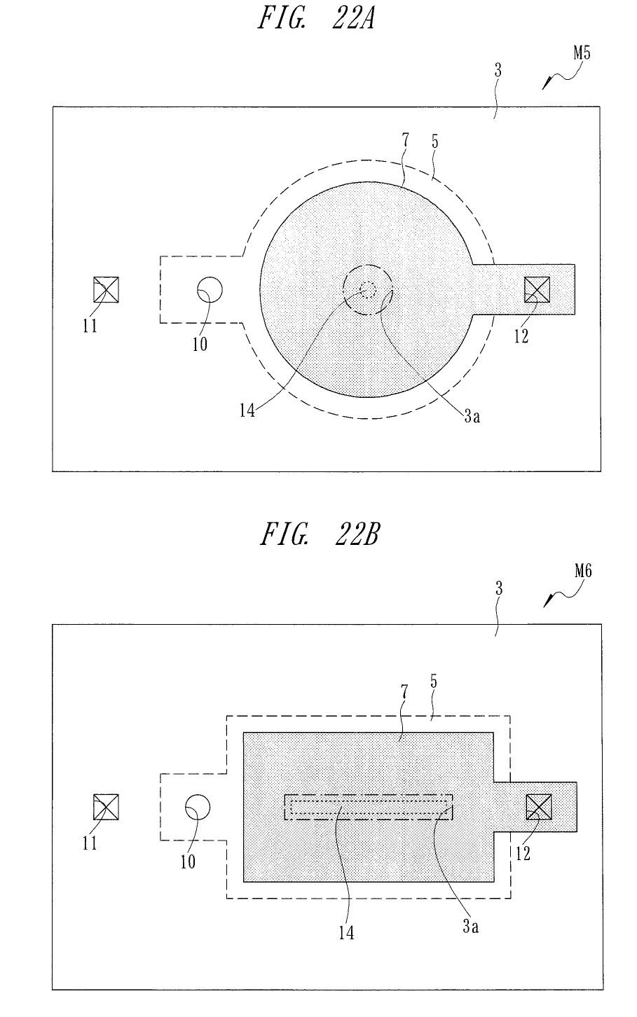

FIGS. 22A and 22B illustrate a plan view of a principal part of an ultrasonic element according to the second embodiment having the cavity portion 5 in a circular shape, and a plan view of a principal part of an ultrasonic element according to the second embodiment having the cavity portion 5 in a rectangular shape, respectively.

In an ultrasonic element M5 having the cavity portion 5 in a circular shape illustrated in FIG. 22A, the contact region 14 formed by the vibration of the membrane 13 is positioned at the center portion of the circle similar to the case of the cavity portion 5 in a hexagonal shape. Therefore, the same effects with the case of cavity portion 5 in a hexagonal shape can be obtained when the opening portion 3a including the contact region 14 therewithin at the center portion of the bottom electrode 3 when viewed in plan view is provided.

In an ultrasonic element M6 having the cavity portion 5 in a rectangular shape illustrated in FIG. 22B, the contact region 14 formed by the vibration of the membrane 13 is positioned at the center portion of the rectangle along the shape of the top electrode 7. Therefore, the same effects with the case of the cavity portion 5 in a hexagonal or circular shape can be obtained when the opening portion 3a including the contact region 14 therewithin when viewed in plan view is provided to the bottom electrode 3.

Further, since the CMUT can be manufactured on a planarized surface, the bottom electrode 3 can be composed of a silicon substrate (semiconductor substrate 1), and, the bottom electrode 3 can be composed of a part of wiring portions of an LSI.

In this manner, according to the second embodiment, by providing the opening portion 3a to the bottom electrode 3, deterioration of the breakdown voltage of the first and second insulating films 4 and 6 between the top electrode 7 and the bottom electrode 3 can be suppressed, thereby obtaining effects similar to those of the above-described first embodiment.

### Third Embodiment

A CMUT according to a third embodiment is similar to that of the above-described first embodiment or second embodiment, and has a structure in which, even when the membrane 13 is vibrated, the first and second insulating films 4 and 6 are not sandwiched by the top electrode 7 and the bottom electrode 3 in the contact region 14 where the second insulating film 6 covering the lower surface of the top electrode 7 and the first insulating film 4 covering the upper surface of the bottom electrode 3 are contacted with each other. A different point of the third embodiment from the first embodiment or the second embodiment is that the opening portion 3a and the opening portion 7a are provided to the bottom electrode 3 and the top electrode 7, respectively.

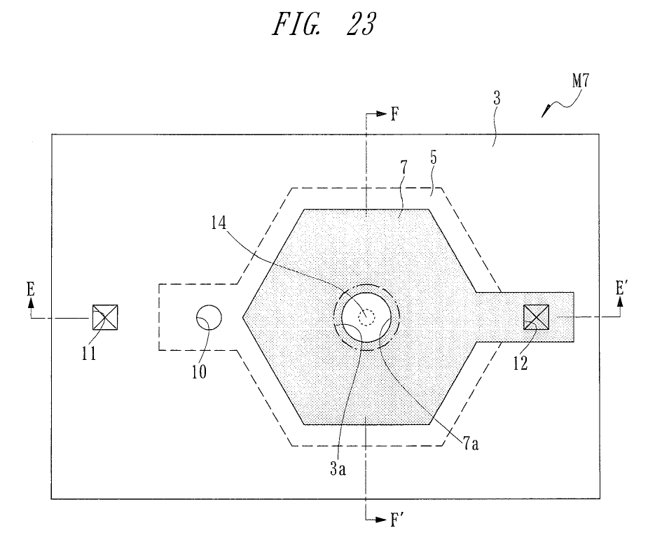

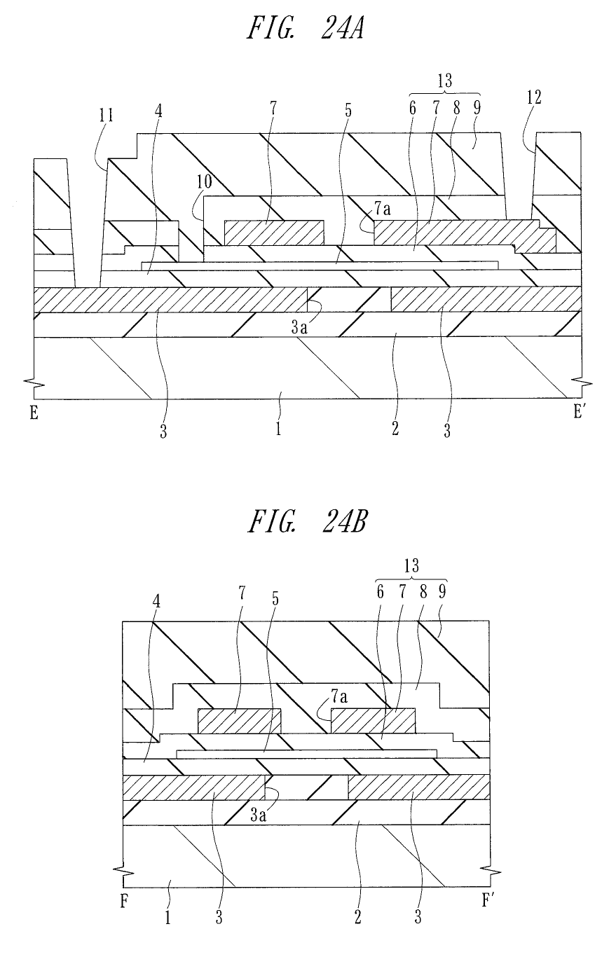

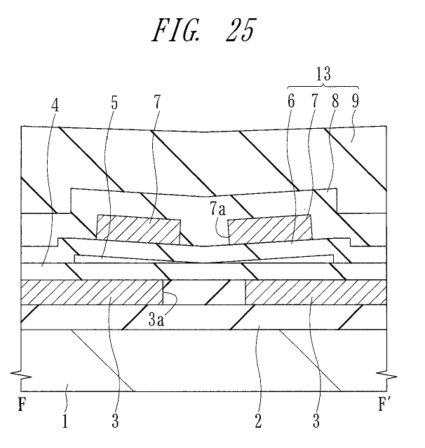

An ultrasonic element composing the CMUT according to the third embodiment will be described with reference to FIGS. 23 to 25. FIG. 23 is a top view of a principal part of an ultrasonic element composing the CMUT, FIG. 24A is a top view of a principal part taken along the line E-E′ of FIG. 23, and FIG. 24B is a cross-sectional view of a principal part taken along the line F-F′ of FIG. 23. And, FIG. 25 is a cross-sectional view of the principal part taken along the line F-F′ of FIG. 23 illustrating one aspect of a membrane vibrating upon driving the CMUT.

As illustrated in FIGS. 23 and 24A-24B, the bottom electrode 3 of an ultrasonic element M7 is formed in an upper layer of the insulating film 2 formed on the main surface of the semiconductor substrate 1, and the opening portion (first opening portion) 3a having a diameter of, e.g., about 10 μm is provided to the bottom electrode 3. The cavity portion 5 is formed in the upper layer of the bottom electrode 3 interposing the first insulating film 4. The shape of the cavity portion 5 viewed from above is hexagonal, and a length of one side thereof is, e.g., about 20 to 30 μm. The opening portion 3a provided to the bottom electrode 3 is provided to be positioned at the center portion of the cavity portion 5 when viewed in plan view. Further, the second insulating film 6 is formed to surround the cavity portion 5, and the top electrode 7 is formed in an upper layer of the second insulating film 6. A shape of the top electrode 7 viewed from above is hexagonal along the shape of the cavity portion 5, and, at the center portion of the top electrode 7, the opening portion (second opening portion) 7a having a diameter of, for example, 10 μm is provided. The third insulating film 8 and the fourth insulating film 9 are sequentially formed in an upper layer of the top electrode 7.

In addition, the etching hole 10 penetrating through the second insulating film 6 and the third insulating film 8 is formed at a leading portion of the hexagonal cavity portion 5. The etching hole 10 is provided for forming the cavity portion 5, and after the cavity portion 5 is formed, the etching hole 10 is filled with the fourth insulating film 9. The pad opening portion 11 reaching the bottom electrode 3 is formed in the first, second, third, and fourth insulating films 4, 6, 8, and 9 in a region where the cavity portion 5 and the top electrode 7 are not formed, so that voltage can be supplied to the bottom electrode 3 via the pad opening portion 11. Further, the pad opening portion 12 reaching the top electrode 7 is formed in the third and fourth insulting films 8 and 9 on the top electrode 7, so that voltage can be supplied to the top electrode 7 via the pad opening portion 12. The membrane 13 to be vibrated upon driving the CMUT is composed of the second insulating film 6, the third insulating film 8, the fourth insulating film 9, and the top electrode 7.

Similar to the first embodiment or the second embodiment described above, in the ultrasonic element M7, the cavity portion 5 has a hexagonal shape when viewed in plan view. Therefore, if DC voltage and AC voltage are supplied across the top electrode 7 and the bottom electrode 3, a maximum displacement point of the vibration of the membrane 13 is the center point of the hexagon. Therefore, a point where a lower surface of the membrane 13 (lower surface of the second insulating film 6) is contacted with the first insulating film 4 covering an upper surface of the bottom electrode 3 is, first, the center point of the hexagonal cavity portion 5, and the contact point becomes the contact region 14 spreading towards the outer peripheral portion from the center point of the cavity portion 5 together with increasing the potential difference between the top electrode 7 and the bottom electrode 3, and the area of the contact region 14 is maximum when the potential difference is maximum. The above-described opening portion 3a formed at the center portion of the bottom electrode 3 and the opening portion 7a formed at the center portion of the top electrode 7 are provided to include the contact region 14 having the maximum area therewithin when viewed in plan view.

FIG. 25 is a diagram illustrating a moment at which the lower surface of the second insulating film 6 covering the lower surface of the top electrode 7 is contacted with the upper surface of the first insulating film 4 covering the upper surface of the bottom electrode 3 by the vibration of the membrane 13, and the area of the contact region 14 is maximum. As the opening portion 3a is formed at the center portion of the bottom electrode 3 and the opening portion 7a is formed at the center portion of the top electrode 7, even when the membrane 13 is vibrated by a voltage allowing the lower surface of the second insulating film 6 to contact with the upper surface of the first insulating film 4 upon driving the CMUT, the first and second insulating films 4 and 6 are not sandwiched by the top electrode 7 and the bottom electrode 3 in the contact region 14. In this manner, current does not readily flow in the contact region 14 and thus deterioration of the breakdown voltage of the first and second insulating films 4 and 6 can be suppressed.

In other words, if the opening portion 3a is not formed at the center portion of the bottom electrode 3 and the opening portion 7a is not formed at the center portion of the top electrode 7, the structure has the first and second insulating films 4 and 6 being sandwiched by the top electrode 7 and the bottom electrode 3 in the contact region 14, so that current flows in the first and second insulating films 4 and 6 in the contact region 14 and thus the breakdown voltage of the first and second insulating films 4 and 6 is deteriorated. However, in the third embodiment, the structure is made such that the opening portion 3a including the contact region 14 having the maximum area therewithin when viewed in plan view is provided to the bottom electrode 3 and the opening portion 7a including the contact region 14 having the maximum area therewithin when viewed in plan view is provided to the top electrode 7 so that the first and second insulating films 4 and 6 are not sandwiched by the top electrode 7 and the bottom electrode 3 in the contact region 14 even when the membrane 13 is vibrated, and thus current does not flow in the first and second insulating films 4 and 6 in the contact region 14, thereby suppressing deterioration of the breakdown voltage of the first and second insulating films 4 and 6. As a result, effects similar to those of the first embodiment can be obtained. Moreover, as compared with the first and second embodiments, the third embodiment provides the opening portion 7a and the opening portion 3a to the top electrode 7 and the bottom electrode 3, respectively. Therefore, there is an advantage of further suppressing the deterioration of the breakdown voltage.

It is considered that, when the opening portion 3a and the opening portion 7a are provided to the top electrode 7 and the bottom electrode 3, respectively, the overlapped area of the top electrode 7 and the bottom electrode 3 viewed from above is small, so that the electric capacitance change upon receiving is small. However, when the areas of the opening portion 3a and the opening portion 7a are about three times the area of the contact region 14, reduction of the overlapped area of the top electrode 7 and the bottom electrode 3 can be at a negligible level.

In addition, while the opening portion 3a larger than the opening portion 7a of the top electrode 7 when viewed in plan view is provided to the bottom electrode 3 for convenience of illustrating the positional relation of the contact region 14 in above-described FIG. 23, it is preferable to provide the opening portion 7a and the opening portion 3a so as to overlap the inner walls of the opening portion 7a and the opening portion 3a when viewed in plan view. More specifically, the inner walls of the opening portions 3a and 7a have a sufficiently low electric field intensity when they are away from the outer rim of the contact region 14 by about a width of the contact region 14 when viewed in plan view, so that desired effects can be obtained. And, if either of the opening portion 3a or the opening portion 7a is larger than the outer rim of the contact region 14, the overlapped area of the top electrode 7 and the bottom electrode 3 is small when viewed in plan view, so that the electrical capacitance upon receiving is small.

In a method of manufacturing the ultrasonic element composing the CMUT according to the third embodiment, the manufacturing process is similar to the manufacturing process of the above-described second embodiment with reference to FIGS. 18 to 21 from the step of forming the bottom electrode 3 and forming the opening portion 3a to the bottom electrode 3 to the step of filling the inside of the opening portion 3a with the fifth insulating film 17. Subsequent manufacturing process of the third embodiment is similar to the manufacturing process of the above-described first embodiment with reference to FIGS. 4 to 13.

Note that, in the third embodiment, while the cavity portion 5 of the ultrasonic element M7 has a hexagonal shape when viewed in plan view in FIG. 23 described above, the shape is not limited to this and it can be any arbitral shape. Also in this case, the opening portion 3a and the opening portion 7a including the contact region 14 therewithin when viewed in plan view can be provided to the bottom electrode 3 and the top electrode 7, respectively, the contact region 14 being a region where the lower surface of the membrane 13 (lower surface of the second insulating film 6 covering the lower surface of the top electrode 7) is contacted with the first insulating film 4 covering the upper surface of the bottom electrode 3 by the vibration of the membrane 13.

Moreover, since the CMUT can be manufactured on a planarized surface, the bottom electrode 3 can be composed of a silicon substrate (semiconductor substrate 1), and the bottom electrode 3 can be composed of a part of wiring portion of an LSI.

Consequently, according to the third embodiment, by providing the opening portion 3a to the bottom electrode 3 and the opening portion 7a to the top electrode 7, deterioration of the breakdown voltage of the first and second insulating films 4 and 6 between the top electrode 7 and the bottom electrode 3 can be suppressed, thereby obtaining effects similar to those of the first embodiment and the second embodiment.

In the foregoing, the invention made by the inventors of the present invention has been concretely described based on the embodiments. However, it is needless to say that the present invention is not limited to the foregoing embodiments and various modifications and alterations can be made within the scope of the present invention.

The CMUT of the present invention can be used for various medical diagnosis equipments using an ultrasonic probe, inspection device of defects within machines, various imaging equipment systems using ultrasonic wave (for detection of blocks, etc.), a position detecting system, a temperature distribution measuring system, and so forth.

1. An ultrasonic transducer comprising:
a first electrode;
a first insulating film formed to cover the first electrode;
a cavity portion formed on the first insulating film so as to overlap with the first electrode when viewed in plan view;
a second insulating film formed to cover the cavity portion; and
a second electrode formed on the second insulating film so as to overlap with the cavity portion when viewed in plan view, wherein
an opening portion is formed at a center portion of the second electrode, and, upon driving the ultrasonic transducer, the opening portion formed to the second electrode includes a region where the first insulating film and the second insulating film are contacted with each other within the opening portion when viewed in plan view.

2. The ultrasonic transducer according to claim 1, wherein
the opening portion formed to the second electrode includes the region where the first insulating film and the second insulating film are contacted with each other within the opening portion when viewed in plan view, when potential difference between the first electrode and the second electrode is maximum.

3. The ultrasonic transducer according to claim 1, wherein
a shape of the region where the first insulating film and the second insulating film are contacted with each other is circular when viewed in plan view.

4. The ultrasonic transducer according to claim 1, wherein
a shape of the region where the first insulating film and the second insulating film are contacted with each other is rectangular when viewed in plan view.

5. The ultrasonic transducer according to claim 3, wherein
an area of the opening portion formed to the second electrode is about three times an area of the region where the first insulating film and the second insulating film are contacted with each other.

6. An ultrasonic transducer comprising:
a first electrode;
a first insulating film formed to cover the first electrode;
a cavity portion formed on the first insulating film so as to overlap with the first electrode when viewed in plan view;
a second insulating film formed to cover the cavity portion; and
a second electrode formed on the second insulating film so as to overlap with the cavity portion when viewed in plan view, wherein
an opening portion is formed at a center portion of the first electrode, and, upon driving the ultrasonic transducer, the opening portion formed to the first electrode includes a region where the first insulating film and the second insulating film are contacted with each other within the opening portion when viewed in plan view.

7. The ultrasonic transducer according to claim 6, wherein
the opening portion formed to the first electrode includes the region where the first insulating film and the second insulating film are contacted with each other within the opening portion when viewed in plan view, when a potential difference between the first electrode and the second electrode is maximum.

8. The ultrasonic transducer according to claim 6, wherein
a shape of the region where the first insulating film and the second insulating film are contacted with each other is circular when viewed in plan view.

9. The ultrasonic transducer according to claim 6, wherein
a shape of the region where the first insulating film and the second insulating film are contacted with each other is rectangular when viewed in plan view.

10. The ultrasonic transducer according to claim 8, wherein
an area of the opening portion formed to the first electrode is about three times an area of the region where the first insulating film and the second insulating film are contacted with each other.

11. An ultrasonic transducer comprising:
a first electrode;
a first insulating film formed to cover the first electrode;
a cavity portion formed on the first insulating film so as to overlap with the first electrode when viewed in plan view;
a second insulating film formed to cover the cavity portion; and
a second electrode formed on the second insulating film so as to overlap with the cavity portion when viewed in plan view, wherein
a first opening portion is formed at a center portion of the first electrode, and a second opening portion is formed at a center portion of the second electrode, and, upon driving the ultrasonic transducer, the first and second opening portions include a region where the first insulating film and the second insulating film are contacted with each other within the first and second opening portions when viewed in plan view.

12. The ultrasonic transducer according to claim 11, wherein
the first and second opening portions include the region where the first insulating film and the second insulating film are contacted with each other within the first and second opening portions when viewed in plan view, when a potential difference between the first electrode and the second electrode is maximum.

13. The ultrasonic transducer according to claim 11, wherein
a shape of the region where the first insulating film and the second insulating film are contacted with each other is circular when viewed in plan view.

14. The ultrasonic transducer according to claim 11, wherein
a shape of the region where the first insulating film and the second insulating film are contacted with each other is rectangular when viewed in plan view.

15. The ultrasonic transducer according to claim 13, wherein
areas of the first and second opening portions are about three times an area of the region where the first insulating film and the second insulating film are contacted with each other.

16-20. (canceled)
